(19) United States
(12) Patent Application Publication
(10) Pub. No.: US 2025/0334544 A1
(43) Pub. Date: Oct. 30, 2025

(54) SENSOR ELEMENT, GAS SENSOR, EVALUATION METHOD FOR SENSOR ELEMENT, AND PROGRAM

(71) Applicant: NGK INSULATORS, LTD., Nagoya-shi (JP)

(72) Inventors: Saki ITO, Nagoya-shi (JP); Shiho IWAI, Nagoya-shi (JP)

(21) Appl. No.: 19/264,072

(22) Filed: Jul. 9, 2025

Related U.S. Application Data
(63) Continuation of application No. PCT/JP2024/000336, filed on Jan. 11, 2024.

(30) Foreign Application Priority Data
Jan. 13, 2023 (JP) 2023-003816

(51) Int. Cl. G01N 27/419

(52) U.S. Cl. CPC G01N 27/419

(57) ABSTRACT

A sensor element includes an element body, an adjustment pump cell having an inner electrode, and a measurement pump cell having a measurement electrode. When a first diffusion resistance from the outside to the inner electrode through a gas inlet is defined as Da, and a second diffusion resistance from the outside to the measurement electrode through the gas inlet is defined as Db, the sensor element is configured such that Db×Db/Da≥3000 [cm⁻¹] is satisfied.

### CROSS-REFERENCE TO RELATED APPLICATION

This application is a continuation application of PCT/JP2024/000336, filed on Jan. 11, 2024, which claims the benefit of priority of Japanese Patent Application No. JP2023-003816, filed on Jan. 13, 2023, the entire contents of which are incorporated herein by reference.

### BACKGROUND OF THE INVENTION

### 1. Field of the Invention

The present invention relates to a sensor element, a gas sensor, an evaluation method for a sensor element, and a program.

### 2. Description of the Related Art

Conventionally, a gas sensor configured to detect a concentration of a specific gas, such as NOx, in a measurement gas, such as exhaust gas from an automobile, is known. For example, PTL 1 discloses a gas sensor including a laminated body with a plurality of oxygen-ion-conductive solid electrolytes and a gas flow path provided therein, the gas flow path configured to introduce and circulate the measurement gas from a gas inlet. The gas sensor also includes a main pump cell with an inner pump electrode disposed in a first internal cavity within the gas flow path, and a measurement pump cell with a measurement electrode disposed in a second internal cavity located downstream of the first internal cavity within the gas flow path. The inner pump electrode is formed as a porous cermet electrode (e.g. a cermet electrode composed of Pt containing 1% Au and zirconia). When detecting the NOX concentration using this gas sensor, the oxygen concentration in the first internal cavity is first adjusted by using the inner pump electrode. Subsequently, NOx contained in the measurement gas, after the oxygen concentration has been adjusted, is reduced in the second internal cavity. Then, the NOx concentration in the measurement gas is detected based on a pump current Ip2 that flows when the oxygen in the second internal cavity is pumped out.

### CITATION LIST

### Patent Literature

PTL 1: Japanese Unexamined Patent Application Publication No. 2014-209128

### SUMMARY OF THE INVENTION

In such a gas sensor, the larger the initial value of the limiting current of the pump current Ip2, the greater the tendency for the sensitivity to detect the NOx concentration to decrease after a predetermined time (e.g. several hundred hours to several thousand hours) of use. A possible cause of the decrease in the sensitivity to detect the NOx concentration is considered to be that a noble metal (e.g. Au) contained in the inner pump electrode and suppressing the catalytic activity of NOx in the measurement gas evaporates from the inner pump electrode. This evaporated noble metal flows through the gas flow path toward the second internal cavity and adheres to the measurement electrode, thereby suppressing the reduction of NOx in the second internal cavity, that is, in the vicinity of the measurement electrode. Thus, in some cases, the gas sensor has exhibited a relatively large decrease in the sensitivity to detect the NOx concentration after the predetermined time of use.

The main object of the sensor element, gas sensor, evaluation method for the sensor element, and program according to the present invention is to provide a sensor element capable of suppressing a decrease in sensitivity to detect the concentration of a specific gas in a measurement gas, after a predetermined time of use.

### Solution to Problem

In order to achieve the above main object, the sensor element, gas sensor, evaluation method for the sensor element, and program according to the present invention employ the following configuration.

[1] A sensor element according to the present invention is a sensor element configured to detect a concentration of a specific gas in a measurement gas, the sensor element includes: an element body having an oxygen-ion-conductive solid electrolyte layer and a measurement gas flow path provided therein, the measurement gas flow path configured to introduce and circulate the measurement gas from a gas inlet; an adjustment pump cell having an inner electrode disposed in an oxygen concentration adjustment chamber within the measurement gas flow path, the inner electrode containing a first type of noble metal with catalytic activity and a second type of noble metal configured to suppress the catalytic activity of the first type of noble metal with respect to the specific gas in the measurement gas, the adjustment pump cell being configured to adjust an oxygen concentration in the oxygen concentration adjustment chamber; and a measurement pump cell having a measurement electrode disposed in a measurement chamber located downstream of the oxygen concentration adjustment chamber within the measurement gas flow path, the measurement pump cell being configured to adjust the oxygen concentration in the measurement chamber, wherein, when a first diffusion resistance from the outside to the inner electrode through the gas inlet is defined as Da, and a second diffusion resistance from the outside to the measurement electrode through the gas inlet is defined as Db, the sensor element is configured such that Db×Db/Da≥3000 [cm⁻¹] is satisfied.

In the sensor element according to the present invention, when the first diffusion resistance from the outside to the inner electrode through the gas inlet is defined as Da, and the second diffusion resistance from the outside to the measurement electrode through the gas inlet is defined as Db, the sensor element is configured such that Db×Db/Da≥3000 [cm⁻¹] is satisfied. This configuration allows suppression of the second type of noble metal that has evaporated from the inner electrode from flowing through the measurement gas flow path toward the measurement electrode and adhering to the measurement electrode. The inventors have confirmed this through experiments and analysis. As a result, it is possible to provide a sensor element capable of suppressing the decrease in sensitivity to detect the concentration of a specific gas, after a predetermined time (e.g. several hundred hours to several thousand hours) of use. Herein, the “second type of noble metal” includes, but is not limited to, Au.

[2] In the sensor element according to the present invention (the sensor element described in [1] above), the sensor element may be configured such that Db×Db/Da=3500 [cm⁻¹] is satisfied. Thus, it is possible to provide a sensor element capable of further suppressing the decrease in sensitivity to detect the concentration of a specific gas, after a predetermined time (e.g. several hundred hours to several thousand hours) of use.

[3] In the sensor element according to the present invention (the sensor element described in [1] or [2] above), the sensor element may include a plurality of the adjustment pump cells, and the first diffusion resistance Da may be a diffusion resistance from the outside to the most upstream inner electrode through the gas inlet. This is because, during use of the sensor element, the vicinity of the most upstream inner electrode has the highest oxygen concentration, and therefore the second type of noble metal is most likely to evaporate from that inner electrode.

[4] In the sensor element according to the present invention (the sensor element described in any one of [1] to [3] above), when the Faraday constant is defined as F [A·sec/mol], the diffusion coefficient of oxygen is defined as D [cm²/sec], the gas constant is defined as R [cm³·atm/mol·K], temperatures of the inner electrode and the measurement electrode are defined as Ta and Tb [K], respectively, limiting currents of the adjustment pump cell and the measurement pump cell are defined as Ipa and Ipb [A], respectively, an oxygen partial pressure in the measurement gas is defined as Poe [atm], and oxygen partial pressures in the oxygen concentration adjustment chamber and the measurement chamber are defined as Poda and Podb [atm], respectively, the first and second diffusion resistances Da and Db may be expressed by Equation (A) and Equation (B), respectively.

$$Da = 4 \times F \times D / ( R \times Ta ) \times 1 / Ipa \times ( Poe - Poda ) \qquad ( A )$$

$$Db = 4 \times F \times D / ( R \times Tb ) \times 1 / Ipb \times ( Poe - Podb ) \qquad ( B )$$

[5] The gas sensor according to the present invention includes the sensor element described in any one of [1] to [4] above. Therefore, the gas sensor according to the present invention can achieve the same effects as the sensor element described above, such as the effect of providing the sensor element capable of suppressing the decrease in the sensitivity to detect the concentration of the specific gas, after the predetermined time of use.

[6] An evaluation method for a sensor element according to the present invention is an evaluation method for a sensor element configured to detect a concentration of a specific gas in a measurement gas, the sensor element includes: an element body having an oxygen-ion-conductive solid electrolyte layer and a measurement gas flow path provided therein, the measurement gas flow path configured to introduce and circulate the measurement gas from a gas inlet; an adjustment pump cell having an inner electrode disposed in an oxygen concentration adjustment chamber within the measurement gas flow path, the inner electrode containing a first type of noble metal with catalytic activity and a second type of noble metal configured to suppress the catalytic activity of the first type of noble metal with respect to the specific gas in the measurement gas, the adjustment pump cell being configured to adjust an oxygen concentration in the oxygen concentration adjustment chamber; and a measurement pump cell having a measurement electrode disposed in a measurement chamber located downstream of the oxygen concentration adjustment chamber within the measurement gas flow path, the measurement pump cell being configured to adjust the oxygen concentration in the measurement chamber, wherein the evaluation method includes a step of evaluating the sensor element under evaluation by using a value of Db×Db/Da, where a first diffusion resistance from the outside to the inner electrode through the gas inlet is defined as Da, and a second diffusion resistance from the outside to the measurement electrode through the gas inlet is defined as Db.

In the evaluation method for the sensor element according to the present invention, the evaluation method evaluates the sensor element under evaluation by using the value of Db×Db/Da, where the first diffusion resistance from the outside to the inner electrode through the gas inlet is defined as Da, and the second diffusion resistance from the outside to the measurement electrode through the gas inlet is defined as Db. This configuration allows evaluation of whether the second type of noble metal evaporated from the inner electrode is suppressed from flowing through the measurement gas flow path toward the measurement electrode and adhering to the measurement electrode. The inventors have confirmed this through experiments and analysis. As a result, it is possible to provide a sensor element capable of suppressing the decrease in sensitivity to detect the concentration of a specific gas, after the predetermined time of use. Herein, the “second type of noble metal” includes, but is not limited to, Au.

[7] In the evaluation method for the sensor element according to the present invention (the evaluation method for the sensor element described in [6] above), in the step, when the Faraday constant is defined as F [A·sec/mol], the diffusion coefficient of oxygen is defined as D [cm²/sec], the gas constant is defined as R [cm³·atm/mol·K], temperatures of the inner electrode and the measurement electrode are defined as Ta and Tb [K], respectively, limiting currents of the adjustment pump cell and the measurement pump cell are defined as Ipa and Ipb [A], respectively, an oxygen partial pressure in the measurement gas is defined as Poe [atm], and oxygen partial pressures in the oxygen concentration adjustment chamber and the measurement chamber are defined as Poda and Podb [atm], respectively, the first and second diffusion resistances Da and Db may be expressed by Equation (C) and Equation (D), respectively.

$$Da = 4 \times F \times D / ( R \times Ta ) \times 1 / Ipa \times ( Poe - Poda ) \qquad ( C )$$

$$Db = 4 \times F \times D / ( R \times Tb ) \times 1 / Ipb \times ( Poe - Podb ) \qquad ( D )$$

[8] A program according to the present invention causes one or more computers to execute the step of the evaluation method for the sensor element according to the present invention (the evaluation method for the sensor element described in [6] or [7] above). This program may be recorded on a computer-readable recording medium (e.g. a hard disk, SSD, ROM, FD, CD, DVD, etc.), may be distributed from one computer to another via a transmission medium (such as a communication network like the Internet or LAN), or may be transferred in other forms. Execution of the program according to the present invention on one or more computers causes the step of the evaluation method for the sensor element according to the present invention to be executed. Therefore, the program according to the present invention can achieve the same effects as the evaluation method for the sensor element according to the present invention, such as the effect of providing the sensor element in which the decrease in the sensitivity to detect the concentration of the specific gas, after the predetermined time of use, is suppressed.

### BRIEF DESCRIPTION OF THE DRAWINGS

FIG. 1 is a schematic cross-sectional view schematically showing an example of a configuration of a gas sensor 100.

FIG. 2 is a block diagram showing the electrical connections between a control device 95 and respective cells and other components.

FIG. 3 is a schematic cross-sectional view of a sensor element 201 according to a modification.

FIG. 4 is a graph showing the relationship between Db×Db/Da and a normalized variation rate ΔIp2s.

### DETAILED DESCRIPTION OF THE INVENTION

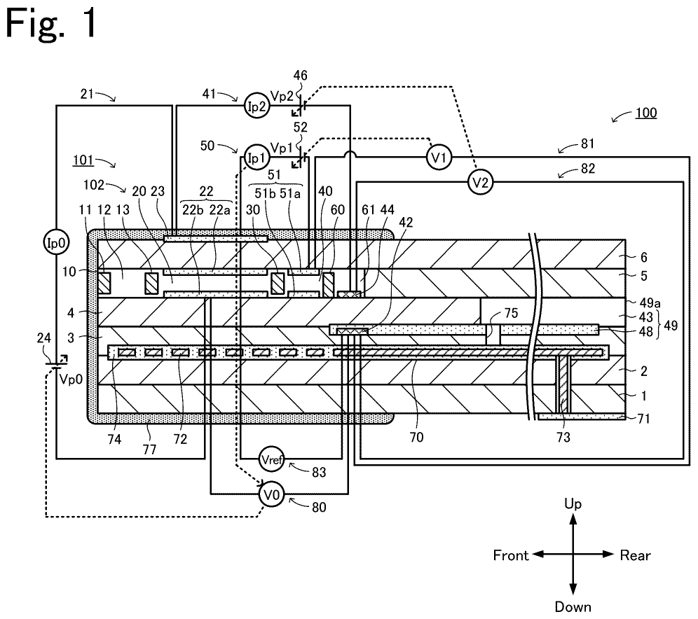

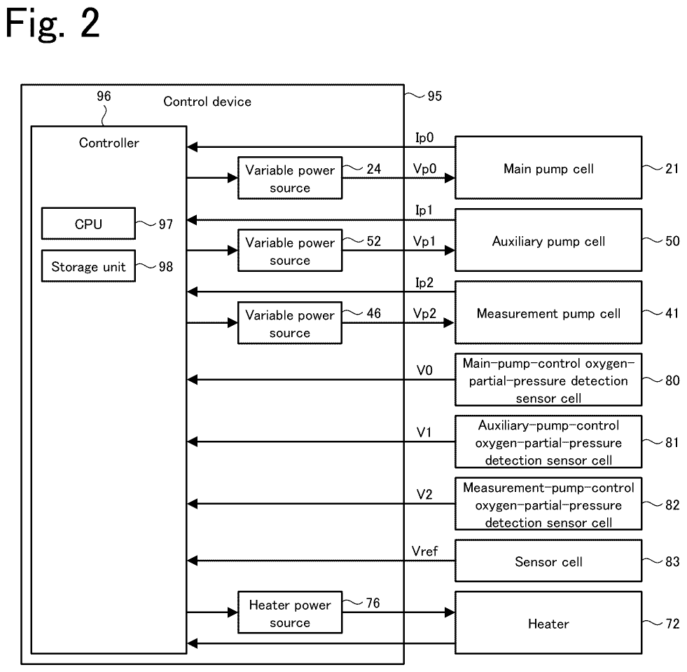

Next, embodiments of the present invention will be described with reference to the drawings. FIG. 1 is a schematic cross-sectional view schematically showing an example of a configuration of a gas sensor 100 according to an embodiment of the present invention. FIG. 2 is a block diagram showing the electrical connections between a control device 95, respective cells and a heater 72. The gas sensor 100 is installed in a pipe, such as an exhaust pipe of an internal combustion engine. The gas sensor 100 detects a concentration of a specific gas, such as NOx or ammonia, in a measurement gas, using exhaust gas from an internal combustion engine as the measurement gas. In the present embodiment, the gas sensor 100 is configured to detect the NOx concentration as the specific gas concentration. The gas sensor 100 includes: a sensor element 101 with an elongated rectangular parallelepiped element body 102; cells 21, 41, 50, and 80 to 83 within the sensor element 101 (that is, in the element body 102); a heater section 70 provided inside the sensor element 101; and a control device 95, which includes variable power sources 24, 46, and 52, and a heater power source 76, and controls the overall operation of the gas sensor 100.

The sensor element 101 (element body 102) is an element that includes a laminated body in which six layers are stacked in the following order from the bottom in the drawing: a first substrate layer 1, a second substrate layer 2, a third substrate layer 3, a first solid electrolyte layer 4, a spacer layer 5, and a second solid electrolyte layer 6. Each of these layers is composed of an oxygen-ion-conductive solid electrolyte layer, such as zirconia (ZrO₂) or the like. The solid electrolytes forming these six layers are dense and hermetically sealed. The element body 102 is manufactured, for example, by performing predetermined processing and printing of circuit patterns on ceramic green sheets corresponding to the respective layers, laminating the sheets, and then firing the laminated sheets to integrate them into a unified structure.

On the front end side (the left end side in FIG. 1) of the sensor element 101 (element body 102), between the lower surface of the second solid electrolyte layer 6 and the upper surface of the first solid electrolyte layer 4, the following components are formed adjacently and connected in sequence: a gas inlet 10; a first diffusion rate-limiting section 11; a buffer space 12; a second diffusion rate-limiting section 13; a first internal cavity (oxygen concentration adjustment chamber) 20; a third diffusion rate-limiting section 30; a second internal cavity (oxygen concentration adjustment chamber) 40; a fourth diffusion rate-limiting section 60; and a third internal cavity (measurement chamber) 61.

The gas inlet 10, buffer space 12, first internal cavity 20, second internal cavity 40, and third internal cavity 61 are internal spaces within the sensor element 101, formed by hollowing out portions of the spacer layer 5. These spaces are bounded at the top by the lower surface of the second solid electrolyte layer 6, at the bottom by the upper surface of the first solid electrolyte layer 4, and on the sides by the side surfaces of the spacer layer 5.

The first diffusion rate-limiting section 11, the second diffusion rate-limiting section 13, and the third diffusion rate-limiting section 30 are each provided as two horizontally elongated slits, with openings oriented along the longitudinal direction perpendicular to the plane of the drawing. The fourth diffusion rate-limiting section 60 is provided as a single horizontally elongated slit, with openings oriented along the longitudinal direction perpendicular to the plane of the drawing, formed as a gap with the lower surface of the second solid electrolyte layer 6. The area extending from the gas inlet 10 to the third internal cavity 61 is also referred to as the measurement gas flow path.

The sensor element 101 (element body 102) includes a reference gas introduction portion 49, which introduces a reference gas from outside of the sensor element 101 to a reference electrode 42 when measuring the NOx concentration. The reference gas introduction portion 49 comprises a reference gas introduction space 43 and a reference gas introduction layer 48. The reference gas introduction space 43 is an inward space formed from the rear end surface of the sensor element 101. The reference gas introduction space 43 is located between the upper surface of the third substrate layer 3 and the lower surface of the spacer layer 5, and is laterally defined by the side surfaces of the first solid electrolyte layer 4. The reference gas introduction space 43 opens to the rear end surface of the sensor element 101, with this opening serving as an inlet portion 49a of the reference gas introduction portion 49. The reference gas is introduced into the reference gas introduction space 43 through the inlet portion 49a. The reference gas introduction portion 49 introduces the reference gas, which has entered through the inlet portion 49a, to the reference electrode 42 while imparting a predetermined diffusion resistance. In the present embodiment, the reference gas is ambient air.

The reference gas introduction layer 48 is provided between the upper surface of the third substrate layer 3 and the lower surface of the first solid electrolyte layer 4. The reference gas introduction layer 48 is a porous body made of a ceramic material such as alumina or the like. A portion of the upper surface of the reference gas introduction layer 48 is exposed within the reference gas introduction space 43. The reference gas introduction layer 48 is formed so as to cover the reference electrode 42. The reference gas introduction layer 48 allows the reference gas to flow from the reference gas introduction space 43 to the reference electrode 42.

The reference electrode 42 is an electrode formed between the upper surface of the third substrate layer 3 and the first solid electrolyte layer 4, and as described above, the reference gas introduction layer 48, which is connected to the reference gas introduction space 43, is provided around the reference electrode 42. Furthermore, as will be explained later, the reference electrode 42 enables the measurement of the oxygen concentration (oxygen partial pressure) in the first internal cavity 20, the second internal cavity 40, and the third internal cavity 61.

In the measurement gas flow path, the gas inlet 10 is a portion that is open to the external space, allowing the measurement gas to be drawn into the sensor element 101 from the external space. The first diffusion rate-limiting section 11 is a part that imparts a predetermined diffusion resistance to the measurement gas introduced through the gas inlet 10. The buffer space 12 is a space provided to guide the measurement gas introduced through the first diffusion rate-limiting section 11 to the second diffusion rate-limiting section 13. The second diffusion rate-limiting section 13 is a portion that imparts a predetermined diffusion resistance to the measurement gas introduced from the buffer space 12 into the first internal cavity 20. When the measurement gas is introduced from outside the sensor element 101 into the first internal cavity 20, the measurement gas that is abruptly drawn into the sensor element 101 through the gas inlet 10 due to pressure fluctuations in the external space (such as exhaust pulsations in the case where the measurement gas is automobile exhaust gas) is not directly introduced into the first internal cavity 20. Instead, after the pressure fluctuations of the measurement gas are attenuated through the first diffusion rate-limiting section 11, the buffer space 12, and the second diffusion rate-limiting section 13, the measurement gas is introduced into the first internal cavity 20. As a result, the pressure fluctuations of the measurement gas introduced into the first internal cavity 20 become almost negligible. The first internal cavity 20 is provided as a space for adjusting the oxygen partial pressure in the measurement gas introduced through the second diffusion rate-limiting section 13. This oxygen partial pressure is adjusted by the operation of a main pump cell 21.

The main pump cell 21 is an electrochemical pump cell, which is constituted by an inner pump electrode 22 with a ceiling electrode portion 22a provided on nearly the entire lower surface of the second solid electrolyte layer 6 facing the first internal cavity 20, an outer pump electrode 23, which is provided in a manner exposed to the outside of the sensor element 101 in a region of the upper surface of the second solid electrolyte layer 6 corresponding to the ceiling electrode portion 22a, and the second solid electrolyte layer 6, the spacer layer 5, and the first solid electrolyte layer 4, which form the current path between these electrodes.

The inner pump electrode 22 is formed so as to extend across the upper and lower solid electrolyte layers, (namely the second solid electrolyte layer 6 and the first solid electrolyte layer 4,) and the spacer layer 5 that provides sidewalls, which together define the first internal cavity 20. Specifically, the ceiling electrode portion 22a is formed on the lower surface of the second solid electrolyte layer 6, which constitutes the ceiling surface of the first internal cavity 20, and a bottom electrode portion 22b is formed on the upper surface of the first solid electrolyte layer 4, which constitutes the bottom surface of the first internal cavity 20. Further, in order to connect the ceiling electrode portion 22a and the bottom electrode portion 22b, side electrode portions (not shown) are formed on the side wall surfaces (inner surfaces) of the spacer layer 5, which constitute both sidewall portions of the first internal cavity 20. The inner pump electrode 22 is disposed in a tunnel-like structure at the region where the side electrode portion is provided.

In the main pump cell 21, a desired voltage Vp0 is applied between the inner pump electrode 22 and the outer pump electrode 23, whereby a pump current Ip0 is caused to flow in a positive direction or a negative direction between the inner pump electrode 22 and the outer pump electrode 23. Thus, the oxygen in the first internal cavity 20 can be pumped out to the external space, or the oxygen in the external space can be pumped into the first internal cavity 20.

Further, in order to detect the oxygen concentration (oxygen partial pressure) in the atmosphere within the first internal cavity 20, an electrochemical sensor cell, that is, a main-pump-control oxygen-partial-pressure detection sensor cell 80, is constituted by the inner pump electrode 22, the second solid electrolyte layer 6, the spacer layer 5, the first solid electrolyte layer 4, the third substrate layer 3, and the reference electrode 42.

By measuring an electromotive force (voltage V0) in the main-pump-control oxygen-partial-pressure detection sensor cell 80, the oxygen concentration (oxygen partial pressure) in the first internal cavity 20 can be determined. Furthermore, by feedback-controlling the voltage Vp0 of the variable power source 24 such that the voltage V0 reaches a target value, the pump current Ip0 is controlled. This configuration allows the oxygen concentration in the first internal cavity 20 to be maintained at a predetermined constant value.

The third diffusion rate-limiting section 30 is a part that imparts a predetermined diffusion resistance to the measurement gas, whose oxygen concentration (oxygen partial pressure) is controlled by the operation of the main pump cell 21 in the first internal cavity 20, and guides the measurement gas into the second internal cavity 40.

The second internal cavity 40 is provided as a space for further adjusting the oxygen partial pressure of the measurement gas, which has already been adjusted for the oxygen concentration (oxygen partial pressure) in the first internal cavity 20, and then being introduced through the third diffusion rate-limiting section 30. This adjustment is carried out by an auxiliary pump cell 50. As a result, the oxygen concentration in the second internal cavity 40 can be maintained at a constant value with high precision, enabling high accuracy NOx concentration measurement in the gas sensor 100.

The auxiliary pump cell 50 is an auxiliary electrochemical pump cell, which is constituted by an auxiliary pump electrode 51 with a ceiling electrode portion 51a provided on nearly the entire lower surface of the second solid electrolyte layer 6 facing the second internal cavity 40, the outer pump electrode 23 (not limited to the outer pump electrode 23, but may be any suitable electrode located outside the sensor element 101), the second solid electrolyte layer 6, the spacer layer 5, and the first solid electrolyte layer 4.

The auxiliary pump electrode 51 is disposed within the second internal cavity 40 in a tunnel-like structure similar to that of the inner pump electrode 22 disposed in the first internal cavity 20 described above. Specifically, the ceiling electrode portion 51a is formed on the second solid electrolyte layer 6, which constitutes the ceiling surface of the second internal cavity 40, and a bottom electrode portion 51b is formed on the first solid electrolyte layer 4, which constitutes the bottom surface of the second internal cavity 40. Further, side electrode portions (not shown), which connect the ceiling electrode portion 51a and the bottom electrode portion 51b, are formed on the inner side surfaces of the spacer layer 5, which constitute both sidewall portions of the second internal cavity 40. Thus, the auxiliary pump electrode 51 is formed in a tunnel-like structure.

In the auxiliary pump cell 50, a desired voltage Vp1 is applied between the auxiliary pump electrode 51 and the outer pump electrode 23. Thus, the oxygen in the atmosphere within the second internal cavity 40 can be pumped out to the external space, or the oxygen can be pumped into the second internal cavity 40 from the external space.

Further, in order to control the oxygen partial pressure in the atmosphere within the second internal cavity 40, an electrochemical sensor cell, that is, an auxiliary-pump-control oxygen-partial-pressure detection sensor cell 81, is constituted by the auxiliary pump electrode 51, the reference electrode 42, the second solid electrolyte layer 6, the spacer layer 5, the first solid electrolyte layer 4, and the third substrate layer 3.

The auxiliary pump cell 50 performs pumping via the variable power source 52, which is voltage-controlled based on an electromotive force (voltage V1) detected by the auxiliary-pump-control oxygen-partial-pressure detection sensor cell 81. As a result, the oxygen partial pressure in the atmosphere within the second internal cavity 40 is controlled to a low level at which it does not substantially affect the measurement of NOx.

In addition, a pump current Ip1 is also used for controlling the electromotive force of the main-pump-control oxygen-partial-pressure detection sensor cell 80. Specifically, the pump current Ip1 is input as a control signal to the main-pump-control oxygen-partial-pressure detection sensor cell 80, and by controlling the above-mentioned target value of the voltage V0, the oxygen partial pressure gradient in the measurement gas introduced from the third diffusion rate-limiting section 30 into the second internal cavity 40 is maintained constant at all times. When used as a NOx sensor, the oxygen concentration in the second internal cavity 40 is maintained at a constant value of approximately 0.001 ppm by the operation of the main pump cell 21 and the auxiliary pump cell 50.

The fourth diffusion rate-limiting section 60 is a part that imparts a predetermined diffusion resistance to the measurement gas, whose oxygen concentration (oxygen partial pressure) is controlled by the operation of the auxiliary pump cell 50 in the second internal cavity 40, and guides the measurement gas into the third internal cavity 61. The fourth diffusion rate-limiting section 60 serves to limit the amount of NOx flowing into the third internal cavity 61.

The third internal cavity 61 is provided as a space for processing the measurement of the nitrogen oxide (NOx) concentration in the measurement gas, which has already been adjusted for the oxygen concentration (oxygen partial pressure) in the second internal cavity 40, and then being introduced through the fourth diffusion rate-limiting section 60. The measurement of the NOx concentration is primarily carried out by the operation of the measurement pump cell 41 in the third internal cavity 61.

The measurement pump cell 41 measures the NOx concentration in the measurement gas within the third internal cavity 61. This measurement pump cell 41 is an electrochemical pump cell, which is constituted by a measurement electrode 44 provided on the upper surface of the first solid electrolyte layer 4 facing the third internal cavity 61, the outer pump electrode 23, the second solid electrolyte layer 6, the spacer layer 5, and the first solid electrolyte layer 4. The measurement electrode 44 also functions as a NOx reduction catalyst, reducing the NOx present in the atmosphere within the third internal cavity 61.

In the measurement pump cell 41, oxygen generated by the decomposition of nitrogen oxides in the atmosphere around the measurement electrode 44 is pumped out, and the amount of oxygen generated can be detected as a pump current Ip2.

Further, in order to detect the oxygen partial pressure around the measurement electrode 44, an electrochemical sensor cell, that is, a measurement-pump-control oxygen-partial-pressure detection sensor cell 82, is constituted by the first solid electrolyte layer 4, the third substrate layer 3, the measurement electrode 44, and the reference electrode 42. Based on the electromotive force (voltage V2) detected by the measurement-pump-control oxygen-partial-pressure detection sensor cell 82, the variable power source 46 is controlled.

The measurement gas introduced into the second internal cavity 40 reaches the measurement electrode 44 in the third internal cavity 61 through the fourth diffusion rate-limiting section 60, under controlled conditions of oxygen partial pressure. Nitrogen oxides present in the measurement gas around the measurement electrode 44 are reduced (2NO→N₂+O₂), thereby generating oxygen. This generated oxygen is then pumped by the measurement pump cell 41. During this process, the voltage Vp2 of the variable power source 46 is controlled to maintain the voltage V2, detected by the measurement-pump-control oxygen-partial-pressure detection sensor cell 82, at a constant (target) value. Since the amount of oxygen generated around the measurement electrode 44 is proportional to the concentration of nitrogen oxides in the measurement gas, the nitrogen oxide concentration in the measurement gas is determined based on the pump current Ip2 of the measurement pump cell 41.

Further, by combining the measurement electrode 44, the first solid electrolyte layer 4, the third substrate layer 3, and the reference electrode 42, an oxygen-partial-pressure detection device can be configured as an electrochemical sensor cell. In this configuration, it is possible to detect an electromotive force corresponding to the difference between the amount of oxygen generated by the reduction of NOx components in the atmosphere around the measurement electrode 44 and the amount of oxygen in a reference atmosphere. This enables the determination of the concentration of NOx components in the measurement gas.

Furthermore, an electrochemical sensor cell 83 is constituted by the second solid electrolyte layer 6, the spacer layer 5, the first solid electrolyte layer 4, the third substrate layer 3, the outer pump electrode 23, and the reference electrode 42. The electromotive force (voltage Vref) detected by this sensor cell 83 enables the detection of the oxygen partial pressure in the measurement gas outside the sensor.

In the gas sensor 100 with such a configuration, the measurement gas, in which the oxygen partial pressure is always maintained at a constant low value (a value that does not substantially affect NOx measurement), is supplied to the measurement pump cell 41 by operating the main pump cell 21 and the auxiliary pump cell 50. Accordingly, the NOx concentration in the measurement gas can be determined based on the pump current Ip2, which flows as oxygen generated by the reduction of NOx is pumped out from the measurement pump cell 41. The amount of this current is substantially proportional to the NOx concentration in the measurement gas.

Each of the electrodes 22, 23, 42, 44, and 51 will be described. The inner pump electrode 22, the auxiliary pump electrode 51, and the measurement electrode 44 each contains a first type of noble metal with catalytic activity. Examples of the first type of noble metal include, but are not limited to, at least one selected from Pt, Rh, Ir, Ru, and Pd. The outer pump electrode 23 and the reference electrode 42 also contain the first type of noble metal. The inner pump electrode 22 and the auxiliary pump electrode 51 further contain second type of noble metal for suppressing the catalytic activity of the first type of noble metal with respect to the specific gas (NOx). As a result, the reducing capability of the inner pump electrode 22 and the auxiliary pump electrode 51 with respect to NOx components in the measurement gas is reduced. An example of the second type of noble metal is Au. The measurement electrode 44 does not contain the second type of noble metal. Accordingly, the reducing capability of the measurement electrode 44 with respect to NOx components in the measurement gas is greater than that of the inner pump electrode 22 and the auxiliary pump electrode 51.

Preferably, the outer pump electrode 23 and the reference electrode 42 also do not contain the second type of noble metal. Each of the electrodes 22, 23, 42, 44, and 51 is preferably a cermet containing a noble metal and an oxide with oxygen ion conductivity (e.g. ZrO₂). Each of the electrodes 22, 23, 42, 44, and 51 is also preferably porous body. In the present embodiment, the inner pump electrode 22 and the auxiliary pump electrode 51 are each porous cermet electrodes composed of Pt containing 1% Au and ZrO₂. The outer pump electrode 23, the reference electrode 42, and the measurement electrode 44 are each porous cermet electrodes composed of Pt and ZrO₂.

The sensor element 101 includes a heater section 70 that performs temperature regulation by heating and maintaining the temperature of the sensor element 101, in order to enhance the oxygen-ion-conductivity of the solid electrolyte. The heater section 70 includes a heater connector electrode 71, a heater 72, a through hole 73, a heater insulating layer 74, and a pressure relief hole 75. The heater connector electrode 71 is an electrode formed in such a manner as to be in contact with the lower surface of the first substrate layer 1. By connecting the heater connector electrode 71 to a heater power source 76 (see FIG. 2), power can be supplied from the heater power source 76 to the heater section 70.

The heater 72 is an electrical resistor formed in such a manner as to be sandwiched between the second substrate layer 2 and the third substrate layer 3 from above and below. The heater 72 is connected to the heater connector electrode 71 via the through hole 73, and generates heat when power is supplied from the heater power source 76 through the heater connector electrode 71, thereby heating and maintaining the temperature of the solid electrolyte forming the sensor element 101.

The heater 72 is also embedded across the entire region from the first internal cavity 20 to the third internal cavity 61, making it possible to adjust the temperature of the entire sensor element 101 to a level at which the solid electrolyte is activated.

The heater insulating layer 74 is an insulating layer formed of an insulator such as alumina and provided on the upper and lower surfaces of the heater 72. The heater insulating layer 74 is formed for the purpose of providing electrical insulation between the second substrate layer 2 and the heater 72, as well as between the third substrate layer 3 and the heater 72.

The pressure relief hole 75 is a portion that penetrates through the third substrate layer 3 and the reference gas introduction layer 48, and is formed so as to communicate with the reference gas introduction space 43. The pressure relief hole 75 is formed for the purpose of relieving an increase in internal pressure caused by a rise in temperature within the heater insulating layer 74.

As shown in FIG. 2, the control device 95 includes the variable power sources 24, 46, and 52 described above, the heater power source 76 also described above, and a control unit 96. The control unit 96 is a microprocessor including a CPU 97 and a storage unit 98. The storage unit 98 is a rewritable non-volatile memory, and is capable of storing, for example, various programs and various kinds of data. The control unit 96 inputs the voltage V0 from the main-pump-control oxygen-partial-pressure detection sensor cell 80, the voltage V1 from the auxiliary-pump-control oxygen-partial-pressure detection sensor cell 81, the voltage V2 from the measurement-pump-control oxygen-partial-pressure detection sensor cell 82, the voltage Vref from the sensor cell 83, the pump current Ip0 flowing through the main pump cell 21, the pump current Ip1 flowing through the auxiliary pump cell 50, and the pump current Ip2 flowing through the measurement pump cell 41. In addition, the control unit 96 controls the voltages Vp0, Vp1, and Vp2 output from the variable power sources 24, 46, and 52, respectively, by outputting control signals to the variable power sources 24, 46, and 52. Through this control, the main pump cell 21, the measurement pump cell 41, and the auxiliary pump cell 50 are controlled. The control unit 96 also controls the power supplied from the heater power source 76 to the heater 72 by outputting a control signal to the heater power source 76. The storage unit 98 also stores target values V0*, V1*, and V2*, which will be described later. The CPU 97 of the control unit 96 performs control of the respective cells 21, 41, and 50 with reference to the target values V0*, V1*, and V2*.

The control unit 96 performs auxiliary pump control processing to control the auxiliary pump cell 50 such that the oxygen concentration in the second internal cavity 40 reaches a target concentration. Specifically, the control unit 96 controls the auxiliary pump cell 50 by feedback-controlling the voltage Vp1 of the variable power source 52 such that the voltage V1 reaches a constant value (referred to as the target value V1*). The target value V1* is set as a value such that the oxygen concentration in the second internal cavity 40 is at a predetermined low concentration that does not substantially affect the NOx measurement.

The control unit 96 performs main pump control processing to control the main pump cell 21 such that the pump current Ip1, which flows when the auxiliary pump cell 50 adjusts the oxygen concentration in the second internal cavity 40 during the auxiliary pump control processing, reaches a target current (referred to as a target value Ip1*). Specifically, the control unit 96 sets (via feedback control) a target value for the voltage V0 (referred to as the target value V0*) based on the pump current Ip1, such that the pump current Ip1 flowing through the voltage Vp1 reaches the constant target value Ip1*. The control unit 96 then feedback-controls the voltage Vp0 of the variable power source 24 such that the voltage V0 reaches the target value V0* (that is, such that the oxygen concentration in the first internal cavity 20 reaches the target concentration). Through this main pump control processing, the gradient of the oxygen partial pressure in the measurement gas, which is introduced from the third diffusion rate-limiting section 30 into the second internal cavity 40, is maintained at a constant value at all times. The target value V0* is set such that the oxygen concentration in the first internal cavity 20 is greater than 0% but is at a low concentration. Additionally, the pump current Ip0 flowing during this main pump control processing changes in accordance with the oxygen concentration of the measurement gas (that is, the measurement gas around the sensor element 101) as it flows from the gas inlet 10 into the measurement gas flow path. As a result, the control unit 96 can also detect the oxygen concentration in the measurement gas based on the pump current Ip0.

The main pump control processing and the auxiliary pump control processing described above are collectively referred to as an adjustment pump control processing. Additionally, the first internal cavity 20 and the second internal cavity 40 are collectively referred to as an oxygen concentration adjustment chamber. The main pump cell 21 and the auxiliary pump cell 50 are collectively referred to as adjustment pump cells. By performing the adjustment pump control processing, the control unit 96 causes the adjustment pump cells to adjust the oxygen concentration in the oxygen concentration adjustment chamber.

Furthermore, the control unit 96 performs measurement pump control processing to control the measurement pump cell 41 such that the voltage V2 reaches a constant value (referred to as the target value V2*) (that is, the oxygen concentration in the third internal cavity 61 reaches a predetermined low level). Specifically, the control unit 96 controls the measurement pump cell 41 by feedback-controlling the voltage Vp2 of the variable power source 46, such that the voltage V2 reaches the target value V2*. Through this measurement pump control processing, oxygen is pumped out of the third internal cavity 61.

Through the performance of the measurement pump control processing, oxygen is pumped out of the third internal cavity 61, such that the oxygen generated by the reduction of NOx in the measurement gas within the third internal cavity 61 is reduced to substantially zero. The control unit 96 then acquires the pump current Ip2 as a detection value corresponding to the oxygen generated in the third internal cavity 61 originating from the specific gas (in this case, NOx), and calculates the NOx concentration in the measurement gas based on this pump current Ip2.

The storage unit 98 stores a formula (such as a linear function or quadratic equation) or a map that defines the correspondence relationship between the pump current Ip2 and the NOx concentration. This formula or map can be determined in advance through experiments.

The control unit 96 performs heater control processing by outputting a control signal to the heater power source 76 such that the temperature of the heater 72 reaches to a target temperature (e.g. 800° C.). Here, the temperature of the heater 72 can be expressed as a linear function of the resistance value of the heater 72. In the heater control processing, the control unit 96 calculates the resistance value of the heater 72, which is a value can be regarded as the temperature of the heater 72 (a value that can be converted into temperature), and feedback-controls the heater power source 76 such that the calculated resistance value reaches to a target resistance value (a value corresponding to the target temperature). The control unit 96 can acquire the voltage of the heater 72 and the current flowing through the heater 72, then calculate the resistance of the heater 72 based on the acquired voltage and current. The control unit 96 may use a three-wire or four-wire method to calculate the resistance, for example. The heater power source 76 adjusts the power supplied to the heater 72 by changing the voltage applied to the heater 72 based on a control signal from the control unit 96 when energizing the heater 72.

In addition, the control device 95, which includes the variable power sources 24, 46, 52, and the heater power source 76 shown in FIG. 2, is actually connected to the electrodes inside the sensor element 101 through unillustrated lead wires formed within the sensor element 101 and unillustrated connector electrodes formed at the rear end of the sensor element 101 (only the heater connector electrode 71 shown in FIG. 1).

Additionally, the element body 102 of the sensor element 101 is covered at the front end portion with a porous protective layer 77, as shown in FIG. 1. This porous protective layer 77 covers portions of both the upper and lower surfaces of the element body 102. Although not shown in the drawing, the porous protective layer 77 also covers portions of the left and right surfaces of the element body 102. The porous protective layer 77 also covers the front surface of the element body 102. The porous protective layer 77 also covers the outer pump electrode 23. The porous protective layer 77 also covers the gas inlet 10. Since the porous protective layer 77 is a porous body, the measurement gas can flow through the inside of the porous protective layer 77 and reach the outer pump electrode 23 and the gas inlet 10. The porous protective layer 77 covers a portion of the element body 102, thereby protecting that part. The porous protective layer 77 functions to prevent the formation of cracks in the element body 102, which could be caused by the adhesion of moisture or other substances from the measurement gas. Additionally, the porous protective layer 77 serves to prevent contaminants, such as oil components contained in the measurement gas, from adhering to the outer pump electrode 23, thereby reducing the deterioration of the outer pump electrode 23. The porous protective layer 77 is a porous body made of a ceramic material, such as alumina.

Next, an example of the manufacturing method for the sensor element 101 of the gas sensor 100 will be described below. First, six pieces of unfired ceramic green sheets, containing an oxygen-ion-conductive solid electrolyte such as zirconia, are prepared as ceramic components. These green sheets are pre-formed with several holes, such as sheet holes used for positioning during printing or lamination, and necessary through-holes. Additionally, the green sheet for the spacer layer 5 is pre-punched to form a space that will serve as the gas flow path for the measurement gas. Similarly, the green sheet for the first solid electrolyte layer 4 is pre-provided with a space that will serve as the reference gas introduction space 43. Then, for each of the first substrate layer 1, second substrate layer 2, third substrate layer 3, first solid electrolyte layer 4, spacer layer 5, and second solid electrolyte layer 6, pattern printing and drying processes are performed to form various patterns on each ceramic green sheet. The patterns to be formed include, for example, the electrodes described above, lead wires connected to each electrode, the reference gas introduction layer 48, and the heater section 70. The pattern printing process is performed by applying a pattern-forming paste, which is prepared according to the required characteristics of each component, onto the green sheets using a well-known screen printing technique. The drying process is also carried out using known drying methods. After the pattern printing and drying process are completed, the printing and drying processes for adhesive paste to laminate and bond the green sheets corresponding to each layer are carried out. The green sheets with adhesive paste are then aligned using positioning holes and laminated in a predetermined order. The lamination process is carried out by applying predetermined temperature and pressure conditions to bond the sheets into a single laminated body. The laminated body obtained in this manner includes multiple element bodies 102. This laminated body is cut into pieces to the size of the element body 102. Then, the cut laminated body is fired at a predetermined firing temperature to obtain the element body 102.

Next, a porous protective layer 77 is formed on the element body 102 to obtain the sensor element 101. The porous protective layer 77 can be formed using at least one of the following methods: plasma spraying, screen printing, gel casting, or dipping. When the porous protective layer 77 is formed by methods involving firing, such as screen printing or dipping, the porous protective layer 77 may be applied to the element body 102 before firing, and both the element body 102 and the porous protective layer 77 may be fired together to obtain the sensor element 101. After obtaining the sensor element 101 in this manner, it can be housed in a predetermined housing and incorporated into a gas sensor body (not shown), thereby resulting in the gas sensor 100.

Here, the fourth diffusion rate-limiting section 60 can be formed, for example, as follows. First, during the pattern printing process described above, a vanishing material (e.g. theobromine) that is eliminated by firing is applied to the upper surface of the portion of the green sheet that will form the partition wall of the spacer layer 5. As a result, during the subsequent firing process, the sacrificial material disappears, and a gap (a horizontally elongated slit) is formed between the upper surface of the partition wall of the spacer layer 5 and the lower surface of the second solid electrolyte layer 6, thereby forming the fourth diffusion rate-limiting section 60. The sacrificial material may also be applied not only to the upper surface of the partition wall portion but also to the portion of the lower surface of the green sheet that will form the second solid electrolyte layer 6 and that faces the partition wall. Furthermore, the vertical height of the slit constituting the fourth diffusion rate-limiting section 60 may be adjusted by controlling the thickness of the applied sacrificial material. The first through third diffusion rate-limiting sections 11, 13, and 30 may also be formed in a similar manner, except that the sacrificial material is applied to both the upper and lower surfaces of the spacer layer 5. It should be noted that such a method for forming diffusion rate-limiting sections is known and is disclosed, for example, in Japanese Patent No. 4911910.

Next, an example of the use of the gas sensor 100 will be described. It is assumed that the CPU 97 of the control device 95 is performing control of the pump cells 21, 41, and 50 (adjustment pump control processing and measurement pump control processing), and is acquiring the respective voltages V0, V1, V2, and Vref from the sensor cells 80 to 83. In this state, when the measurement gas is introduced into the element body 102 through the gas inlet 10, the measurement gas first flows, in this order, through the first diffusion rate-limiting section 11, the buffer space 12, and the second diffusion rate-limiting section 13, and reaches the first internal cavity 20. Subsequently, in the first internal cavity 20 and the second internal cavity 40, the oxygen concentration of the measurement gas is adjusted by the main pump cell 21 and the auxiliary pump cell 50. The measurement gas after adjustment then reaches the third internal cavity 61. Thereafter, the CPU 97 acquires the pump current Ip2 and detects the NOx concentration in the measurement gas based on the acquired pump current Ip2.

In the present embodiment, the sensor element 101 is configured such that, when a first diffusion resistance, which is a diffusion resistance of the first portion from the outside to the inner pump electrode 22 via the porous protective layer 77 and the gas inlet 10, is defined as Da, and a second diffusion resistance, which is a diffusion resistance of the second portion from the outside to the measurement electrode 44 via the porous protective layer 77 and the gas inlet 10, is defined as Db, the first diffusion resistance Da is in the range of 200 to 670 [cm⁻¹], and the second diffusion resistance Db is in the range of 780 to 2700 [cm⁻¹], and furthermore, Db×Db/Da≥3000 [cm⁻¹] is satisfied. Preferably, the sensor element 101 is configured such that Db×Db/Da≥3500 [cm⁻¹] is satisfied. More preferably, the sensor element 101 is configured such that Db×Db/Da≥5000 [cm⁻¹] is satisfied.

Here, the first and second diffusion resistances Da and Db are respectively expressed by Equation (1) and Equation (2), when the Faraday constant is defined as F [A·sec/mol], the diffusion coefficient of oxygen is defined as D [cm²/sec], the gas constant is defined as R [cm³·atm/mol·K], the temperatures of the inner pump electrode 22 and the measurement electrode 44 are defined as Ta and Tb [K], respectively, the limiting currents of the main pump cell 21 and the measurement pump cell 41 are defined as Ipa and Ipb [A], respectively, the oxygen partial pressure in the measurement gas is defined as Poe [atm], and the oxygen partial pressures in the first internal cavity 20 and the third internal cavity 61 are defined as Poda and Podb [atm], respectively.

$$Da = 4 \times F \times D / ( R \times Ta ) \times 1 / Ipa \times ( Poe - Poda ) \qquad ( 1 )$$

$$Db = 4 \times F \times D / ( R \times Tb ) \times 1 / Ipb \times ( Poe - Podb ) \qquad ( 2 )$$

In Db×Db/Da, the first Db indicates the degree of difficulty in the flow of the second type of noble metal (e.g. Au) evaporated from the inner pump electrode 22 toward the third internal cavity 61. As is apparent from Equation (2), the first Db is negatively correlated with the limiting current Ipb of the measurement pump cell 41. In addition, Db/Da represents the balance between the flow of the second type of noble metal evaporated from the inner pump electrode 22 toward the gas inlet 10 and that toward the third internal cavity 61.

In Equations (1) and (2), the Faraday constant F is set to 96490 [A·sec/mol] in the present embodiment. The diffusion coefficient D of oxygen is set to 1.6 [cm²/sec] in the present embodiment. The gas constant R is set to 82.05 [cm³·atm/mol·K] in the present embodiment.

In Equations (1) and (2), the limiting current Ipa of the main pump cell 21, in the present embodiment, is the limiting current value of the pump current Ip0 obtained when oxygen is pumped out from around the inner pump electrode 22 to around the outer pump electrode 23, under a condition in which the gas inlet 10 of the sensor element 101 is exposed to an ambient gas in which the base gas is nitrogen, the oxygen concentration is 218, and the pressure is 1 atm. The limiting current Ipb of the measurement pump cell 41, in the present embodiment, is the limiting current value of the pump current Ip2 obtained when oxygen is pumped from around the measurement electrode 44 to around the outer pump electrode 23, under a condition in which the gas inlet 10 of the sensor element 101 is exposed to an ambient gas in which the base gas is nitrogen, the oxygen concentration is 21%, and the pressure is 1 atm.

The limiting current Ipa of the main pump cell 21 can be measured, for example, as follows. First, the gas inlet 10 of the sensor element 101 is exposed to an ambient gas in which the base gas is nitrogen, the oxygen concentration is 218, and the pressure is 1 atm. For example, the gas sensor 100 including the sensor element 101 is installed in a pipe such that the tip side portion of the sensor element 101 protrudes into the pipe, and the ambient gas is flowed through the pipe, whereby the gas inlet 10 of the sensor element 101 is exposed to this ambient gas. Although the oxygen concentration around the reference gas introduction portion 49 does not significantly affect the measured value of the limiting current Ipa, the reference gas introduction portion 49 is exposed to the atmosphere. Subsequently, the heater 72 is energized to heat the sensor element 101 to a predetermined operating temperature Tset (e.g. 800° C.). At this time, none of the variable power sources 24, 46, and 52 apply voltage. After the temperature of the sensor element 101 has stabilized, a voltage Vp0 is applied between the inner pump electrode 22 and the outer pump electrode 23 by the variable power source 24 such that oxygen is pumped out from around the inner pump electrode 22 to around the outer pump electrode 23. During this operation, the pump current Ip0 (oxygen pumping out current) flowing between the electrodes 22 and 23 is then measured. The voltage Vp0 is a direct current (DC) voltage. Then, as the voltage Vp0 is gradually increased, the pump current Ip0 also gradually increases. However, eventually, even if the voltage Vp0 is further increased, the pump current Ip0 does not increase and reaches its upper limit. The pump current Ip0 at this time is measured as the limiting current Ipa. The flow rate of the gas reaching around the inner pump electrode 22, through the porous protective layer 77 and the gas inlet 10 from the outside, depends on the diffusion resistance of the portion that is the gas path from the outside to the inner pump electrode 22 (the first diffusion resistance Da described above). The diffusion resistances of the first and second diffusion rate-limiting sections 11 and 13, and the like, particularly affect the first diffusion resistance Da. The limiting current Ipa and the first diffusion resistance Da have a negative correlation (see Equation (1)), and the larger the limiting current Ipa, the smaller the first diffusion resistance Da becomes. The limiting current Ipa and the first diffusion resistance Da can be adjusted by changing, for example, the lateral length, the longitudinal length in the front-rear direction, and the vertical height of the slits of the first and second diffusion rate-limiting sections 11 and 13.

The limiting current Ipb of the measurement pump cell 41 can be measured, for example, as follows. Similar to the measurement of the limiting current Ipa of the main pump cell 21, first, the gas inlet 10 of the sensor element 101 is exposed to an ambient gas in which the base gas is nitrogen, the oxygen concentration is 21%, and the pressure is 1 atm, and the reference gas introduction portion 49 is exposed to the atmosphere. Subsequently, the limiting current Ipb is measured in the same manner as the measurement of the limiting current Ipa, except that a voltage Vp2 is applied between the measurement electrode 44 and the outer pump electrode 23 by the variable power source 46 such that oxygen is pumped out from around the measurement electrode 44 to around the outer pump electrode 23. Specifically, the pump current Ip2 when the pump current Ip2 does not increase even if the voltage Vp2 is increased and reaches an upper limit is measured as the limiting current Ipb. The flow rate of the gas reaching around the measurement electrode 44 from the outside through the porous protective layer 77 and the gas inlet 10 depends on the diffusion resistance of the part that is the gas path from the outside to the measurement electrode 44 (the second diffusion resistance Db described above). The diffusion resistances of the first to fourth diffusion rate-limiting sections 11, 13, 30, and 60, and the like, particularly affect the second diffusion resistance Db. The limiting current Ipb and the second diffusion resistance Db have a negative correlation (see Equation (2)), and the larger the limiting current Ipb, the smaller the second diffusion resistance Db becomes. The limiting current Ipb and the second diffusion resistance Db can be adjusted by changing, for example, the lateral length, the longitudinal length in the front-rear direction, and the vertical height of the slits of the first to fourth diffusion rate-limiting sections 11, 13, 30, and 60.

In Equations (1) and (2), the temperatures Ta and Tb of the inner pump electrode 22 and the measurement electrode 44 are estimated values of the temperatures of the inner pump electrode 22 and the measurement electrode 44 when the limiting currents Ipa and Ipb of the main pump cell 21 and the measurement pump cell 41 are measured, when the adjustment pump control processing described above (the auxiliary pump control processing using the target value V1* described above, and the main pump control processing) is performed, and when the measurement pump control processing is performed. In the present embodiment, the temperatures Ta and Tb are measured as follows. First, a temperature measurement sample is manufactured in which resistance elements for temperature measurement are disposed at the respective positions of the inner pump electrode 22 and the measurement electrode 44 of the sensor element 101. Subsequently, the heater 72 of the temperature measurement sample is energized to heat the sensor element 101 to the operating temperature Tset described above, and when the temperature of the sensor element 101 becomes stable, the temperatures calculated from the resistance values of the respective resistance elements are measured as the temperatures Ta and Tb. Alternatively, the temperatures Ta and Tb may also be measured by a method such as thermographic measurement, once the heater 72 of the sensor element 101 is energized to heat the sensor element 101 to the predetermined operating temperature Tset and the temperature of the sensor element 101 becomes stable. In the present embodiment, both the temperatures Ta and Tb of the inner pump electrode 22 and the measurement electrode 44 were set to 1123 K.

In Equations (1) and (2), the oxygen partial pressure Poe in the measurement gas is an estimated value of the oxygen partial pressure in the measurement gas when measuring the limiting currents Ipa and Ipb of the main pump cell 21 and the measurement pump cell 41. In the present embodiment, since an ambient gas in which the base gas is nitrogen, the oxygen concentration is 218, and the pressure is 1 atm is used, the oxygen partial pressure Poe is a partial pressure corresponding to the oxygen concentration of 21%.

The oxygen partial pressure Poda in the first internal cavity 20 is the oxygen partial pressure corresponding to the oxygen concentration in the first internal cavity 20, which is adjusted by performing the adjustment pump control processing described above (the auxiliary pump control processing using the target value V1* described above, and the main pump control processing). The oxygen partial pressure Podb in the third internal cavity 61 is the oxygen partial pressure corresponding to the oxygen concentration in the third internal cavity 61, which is adjusted by performing the measurement pump control processing such that the voltage V2 reaches the target value V2*. In the present embodiment, the target value V2* is set to 400 mV. For example, the oxygen partial pressure Poda can be obtained by acquiring the voltage V0 and an oxygen partial pressure Podr of the reference gas (air) when the adjustment pump control processing is performed, and applying these to a predetermined correspondence relationship between the voltage V0, the oxygen partial pressure Podr, and the oxygen partial pressure Poda. Similarly, the oxygen partial pressure Podb can be obtained by acquiring the voltage V2 and the oxygen partial pressure Podr of the reference gas (air) when the measurement pump control processing is performed, and applying these to a predetermined correspondence relationship between the voltage V2, the oxygen partial pressure Podr, and the oxygen partial pressure Podb.

In the present embodiment, the value obtained by subtracting the oxygen partial pressure Poda in the first internal cavity 20 from the oxygen partial pressure Poe in the measurement gas (Poe-Poda) is set to 0.20999 atm. In the present embodiment, the value obtained by subtracting the oxygen partial pressure Podb in the third internal cavity 61 from the oxygen partial pressure Poe in the measurement gas (Poe-Podb) is set to 0.00049999 atm.

In the gas sensor 100, as the initial value of the limiting current Ipb of the measurement pump cell 41 increases, that is, as the reciprocal of the initial value of the second diffusion resistance Db increases, there is a tendency for the sensitivity to detect the NOx concentration to decrease to a greater extent after a predetermined time (e.g. several hundred to several thousand hours) of use. One possible cause of the reduction in sensitivity to detect the NOx concentration is as follows. A second type of noble metal contained in the inner pump electrode 22 evaporates from the electrode. If the evaporated second type of noble metal flows toward the third internal cavity 61 and adheres to the measurement electrode 44, the adhered second type of noble metal suppresses the catalytic activity of the measurement electrode 44 and thereby inhibits the reduction of NOx in the vicinity of the measurement electrode 44. For this reason, the actual pump current Ip2 decreases compared to the correct pump current Ip2 corresponding to the NOx concentration. That is, the sensitivity to detect the NOx concentration decreases. Since the first and second diffusion resistances Da and Db have a negative correlation with the limiting currents Ipa and Ipb, respectively, the larger the Db×Db/Da, that is, the smaller the limiting current Ipb and the larger the limiting current Ipa, the more difficult it becomes for the second type of noble metal evaporated from the inner pump electrode 22 to flow toward the third internal cavity 61 side and the easier it becomes for the second type of noble metal to flow toward the gas inlet 10 side. In the present embodiment, since the sensor element 101 is configured to satisfy Db×Db/Da≥3000 [cm⁻¹], it is possible to suppress the second type of noble metal evaporated from the inner pump electrode 22 from flowing toward the third internal cavity 61 side and adhering to the measurement electrode 44. The inventors have confirmed this through experiments and analysis. As a result, it is possible to provide the sensor element 101 capable of suppressing the decrease in the sensitivity to detect the NOx concentration, after the predetermined time of use. Furthermore, by suppressing the decrease in the sensitivity to detect the NOx concentration after the predetermined time of use, it is easy to predict the degree of decrease in the sensitivity to detect the NOx concentration even after long-term use, so it is possible to accurately detect the NOx concentration even after long-term use by correction or the like.

It should be noted that the auxiliary pump electrode 51 also contains the second type of noble metal, similarly to the inner pump electrode 22. However, during use of the sensor element 101, the oxygen concentration around the auxiliary pump electrode 51 is lower than that around the inner pump electrode 22. Therefore, the second type of noble metal is less likely to evaporate from the auxiliary pump electrode 51 than from the inner pump electrode 22. This is due to the following reason. The evaporation of the second type of noble metal from the electrode is more likely to occur at higher oxygen concentrations. For example, in an electrode containing Pt and Au, Pt is more likely to oxidize to PtO₂ at higher oxygen concentrations. Since PtO₂ has a saturation higher vapor pressure than Pt, it is more likely to evaporate than Pt. Furthermore, when Pt becomes PtO₂ and evaporates, Au is also more likely to evaporate. The reason for this is that Au alone has a higher saturation vapor pressure than the Pt—Au alloy. For these reasons, the second type of noble metal is less likely to evaporate from the auxiliary pump electrode 51 than from the inner pump electrode 22. The inventors have confirmed through experiments and analysis that the amount of the second type of noble metal evaporated from the auxiliary pump electrode 51 is negligibly small and thus has little effect on the decrease in the pump current Ip2 after the predetermined period of time.

Here, the correspondence relationship between the elements according to the present embodiment and the elements according to the present invention will be clarified. Each of the first substrate layer 1, the second substrate layer 2, the third substrate layer 3, the first solid electrolyte layer 4, the spacer layer 5, and the second solid electrolyte layer 6 according to the present embodiment corresponds to the solid electrolyte layer according to the present invention. The element body 102 corresponds to the element body. The inner pump electrode 22 and the auxiliary pump electrode 51 correspond to the inner electrode. The main pump cell 21 and the auxiliary pump cell 50 correspond to the adjustment pump cell. The measurement electrode 44 corresponds to the measurement electrode. The measurement pump cell 41 corresponds to the measurement pump cell.

In the sensor element 101 included in the gas sensor 100 according to the present embodiment described in detail above, the sensor element 101 is configured such that Db×Db/Da≥3000 [cm⁻¹] is satisfied. This configuration allows for the suppression of the second type of noble metal (e.g. Au) evaporated from the inner pump electrode 22 from flowing toward the third internal cavity 61 and adhering to the measurement electrode 44. As a result, it is possible to provide the sensor element 101 capable of suppressing the decrease in the sensitivity to detect the NOx concentration, after a predetermined time (e.g. several hundred hours to several thousand hours) of use.

In addition, in the sensor element 101, by being configured to satisfy Db×Db/Da≥3500 [cm⁻¹], it is possible to further suppress the second type of noble metal from flowing to the third internal cavity 61 side and adhering to the measurement electrode 44.

It should be noted that the present invention is not limited to the present embodiment described above in any way, and it goes without saying that the present invention can be implemented in various modes as long as they fall within the technical scope of the present invention.

In the embodiment described above, the inner pump electrode 22 and the auxiliary pump electrode 51 are formed as porous cermet electrodes composed of Pt containing 1% Au and ZrO₂, and the outer pump electrode 23, the reference electrode 42, and the measurement electrode 44 are all formed as porous cermet electrodes composed of Pt and ZrO₂. However, one or more of the electrodes 22, 23, 42, 44, and 51 may not be cermet. In addition, one or more of the electrodes 22, 23, 42, 44, and 51 may not be porous body.

In the embodiment described above, the first and second diffusion resistances Da and Db of the sensor element 101 are calculated using Equations (1) and (2) described above. However, this is not limited to such a configuration. For example, the first diffusion resistance Da may be calculated based on the shape (lateral length, longitudinal length in the front-rear direction, and vertical height) of the slits of the first and second diffusion rate-limiting sections 11 and 13, and the second diffusion resistance Db may be calculated based on the shape of the slits of the first to fourth diffusion rate-limiting sections 11, 13, 30, and 60, and the like.

In the embodiment described above, the oxygen concentration adjustment chamber included the first internal cavity 20 and the second internal cavity 40, but the present invention is not limited thereto. For example, the oxygen concentration adjustment chamber may further include another internal cavity, or one of the first internal cavity 20 and the second internal cavity 40 may be omitted. Similarly, in the embodiment described above, the adjustment pump cell included the main pump cell 21 and the auxiliary pump cell 50, but the present invention is not limited thereto. For example, the adjustment pump cell may further include another pump cell, or one of the main pump cell 21 and the auxiliary pump cell 50 may be omitted. For example, if the oxygen concentration of the measurement gas can be sufficiently lowered by the main pump cell 21 alone, the auxiliary pump cell 50 may be omitted. When the auxiliary pump cell 50 is omitted, the control unit 96 only needs to perform the main pump control processing as the adjustment pump control processing. In addition, in the main pump control processing, the setting of the target value V0* based on the pump current Ip1 described above may be omitted. Specifically, a predetermined target value V0* is stored in the storage unit 98 in advance, and the control unit 96 controls the voltage Vp0 of the variable power source 24 by feedback control such that the voltage V0 reaches the target value V0*, thereby controlling the main pump cell 21. In this case, for example, the oxygen partial pressure Poda can be obtained by acquiring the voltage V0 and the oxygen partial pressure Podr of the reference gas (air) when the main pump control processing is being performed, and applying these to a predetermined correspondence relationship between the voltage V0, the oxygen partial pressure Podr, and the oxygen partial pressure Poda.

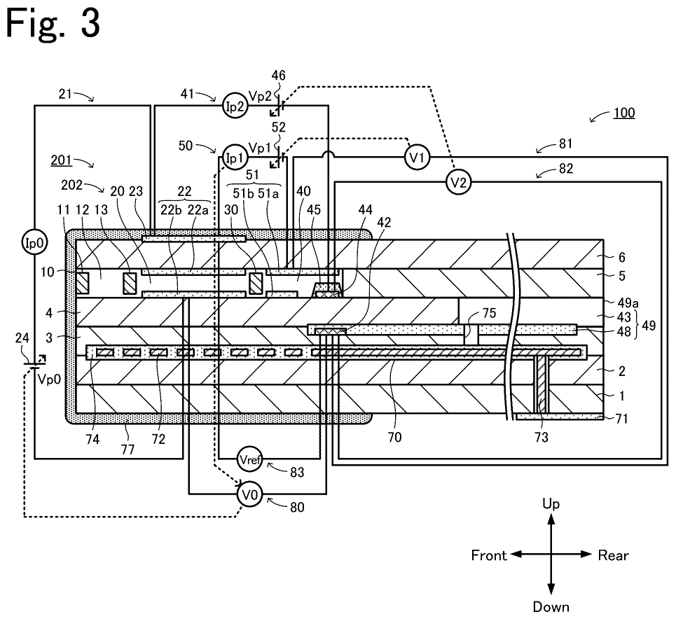

In the embodiment described above, the element body 102 of the sensor element 101 of the gas sensor 100 includes the first internal cavity 20, the second internal cavity 40, and the third internal cavity 61. However, this is not limited to such a configuration. For example, as shown in FIG. 3, an element body 202 of a modified sensor element 201 may not include the third internal cavity 61. In the element body 202 of the modified sensor element 201 shown in FIG. 3, between the lower surface of the second solid electrolyte layer 6 and the upper surface of the first solid electrolyte layer 4, the following components are adjacently formed and in communication with each other, in the order listed: a gas inlet 10; a first diffusion rate-limiting section 11; a buffer space 12; a second diffusion rate-limiting section 13; a first internal cavity 20; a third diffusion rate-limiting section 30; and a second internal cavity 40. In addition, the measurement electrode 44 is disposed on the upper surface of the first solid electrolyte layer 4 within the second internal cavity 40. The measurement electrode 44 is covered with a fourth diffusion rate-limiting section 45, which is a film made of a porous ceramic material such as alumina (Al₂O₃). The fourth diffusion rate-limiting section 45 serves to limit the amount of NOx flowing to the measurement electrode 44, similarly to the fourth diffusion rate-limiting section 60 of the embodiment described above. Furthermore, the fourth diffusion rate-limiting section 45 also functions as a protective film for the measurement electrode 44. The ceiling electrode portion 51a of the auxiliary pump electrode 51 extends directly above the measurement electrode 44. Even with such a configuration of the sensor element 201, the NOx concentration can be detected based on, for example, the pump current Ip2, similarly to the embodiment described above. In this case, the region around the measurement electrode 44 functions as the measurement chamber.

In the embodiment described above, the outer pump electrode 23 serves multiple functions: as an electrode (also referred to as the outer main pump electrode) paired with the inner pump electrode 22 in the main pump cell 21; as an electrode (also referred to as the outer auxiliary pump electrode) paired with the auxiliary pump electrode 51 in the auxiliary pump cell 50; and as an electrode (also referred to as the outer measurement electrode) paired with the measurement electrode 44 in the measurement pump cell 41. However, this is not limited to such a configuration. For example, at least one of the outer main pump electrode, the outer auxiliary pump electrode, and the outer measurement electrode may instead be provided separately from the outer pump electrode 23 and arranged on the outer side of the element body, in contact with the measurement gas.

In the embodiment described above, the element body 102 of the sensor element 101 is configured to have its front end portion covered with the porous protective layer 77. However, the front end portion may alternatively be exposed without the porous protective layer 77. The inventors have confirmed through experiments and analysis that the presence or absence of the porous protective layer 77 has a sufficiently small effect on the limiting currents Ipa and Ipb of the main pump cell 21 and the measurement pump cell 41, and consequently on the value of Db×Db/Da. Accordingly, even in such a case, the sensor element 101 may be configured to satisfy Db×Db/Da≥3000 [cm⁻¹]. Preferably, the sensor element 101 is configured to satisfy Db×Db/Da≥3500 [cm⁻¹].

In the embodiment described above, the sensor element 101 is configured to detect the NOx concentration in the measurement gas. However, this is not limited to such a configuration, and it may be used to detect the concentration of the specific gas in the measurement gas. For example, the specific gas concentration may be an oxide concentration other than NOx. In a case where the specific gas is an oxide, oxygen is generated through the reduction of the specific gas itself in the third internal cavity 61, as in the above-described embodiment. Accordingly, the measurement pump cell 41 can detect the concentration of the specific gas by acquiring a detection value (e.g. the pump current Ip2) corresponding to the amount of oxygen thus generated. Alternatively, the specific gas may be a non-oxide such as ammonia. In this case, the specific gas is first converted into an oxide (e.g., ammonia into NO), and oxygen is thereby generated through the reduction of the converted gas in the third internal cavity 61. Accordingly, the measurement pump cell 41 can detect the concentration of the specific gas by acquiring a detection value (e.g. the pump current Ip2) corresponding to the oxygen generated in this process. For example, the inner pump electrode 22 located in the first internal cavity 20 may function as a catalyst for converting ammonia into NO within the first internal cavity 20.

In the embodiments described above, the element body 102 of the sensor element 101 is formed as the laminated body including multiple solid electrolyte layers (layers 1 to 6). However, this is not limited to such a configuration. The element body 102 of the sensor element 101 only needs to include at least one oxygen ion-conductive solid electrolyte layer. For example, in FIG. 1, layers 1 to 5, except for the second solid electrolyte layer 6, may be formed of materials other than solid electrolyte (such as alumina). In such a case, each electrode included in the sensor element 101 may be disposed on the second solid electrolyte layer 6. For instance, the measurement electrode 44 shown in FIG. 1 may be disposed on a lower surface of the second solid electrolyte layer 6. Furthermore, the reference gas introduction space 43, which is formed in the first solid electrolyte layer 4, may instead be formed in the spacer layer 5. Likewise, the reference gas introduction layer 48, located between the first solid electrolyte layer 4 and the third substrate layer 3, may instead be provided between the second solid electrolyte layer 6 and the spacer layer 5. In addition, the reference electrode 42 may be provided on the lower surface of the second solid electrolyte layer 6 at a position downstream of the third internal cavity 61.

In the embodiments described above, the control unit 96 performs feedback control by setting a target value V0* for the voltage V0 based on the pump current Ip1, such that the pump current Ip1 reaches a target value Ip1*. The control unit then adjusts the pump voltage Vp0 such that the voltage V0 reaches the target value V0*. However, other control methods may also be employed. For example, the control unit 96 may perform feedback control of the pump voltage Vp0 based on the pump current Ip1, such that the pump current Ip1 reaches the target value Ip1*. In other words, the control unit 96 may bypass acquiring the voltage V0 from the oxygen partial pressure detection sensor cell 80 used for main pump control and setting the target value V0*, and instead directly control the pump voltage Vp0 (and thus the pump current Ip0) based on the pump current Ip1.

In the embodiment described above, the configuration of the sensor element 101 included in the gas sensor 100 has been described. Next, an evaluation method for the sensor element 101 will be described. First, a sensor element 101 to be evaluated and a corresponding temperature measurement sample are manufactured using the manufacturing method described above. Subsequently, for the sensor element 101 to be evaluated and the corresponding temperature measurement sample, the following parameters are obtained using the measurement method described above: the limiting currents Ipa and Ipb of the main pump cell 21 and the measurement pump cell 41; the temperatures Ta and Tb of the inner pump electrode 22 and the measurement electrode 44; the oxygen partial pressure Poe in the measurement gas; and the oxygen partial pressures Poda and Podb in the first internal cavity 20 and the third internal cavity 61, respectively. Then, a computer inputs various data related to the sensor element 101 to be evaluated, calculates the first and second diffusion resistances Da and Db using Equations (1) and (2) described above, calculates a value of Db×Db/Da using the calculated first and second diffusion resistances Da and Db, and evaluates the sensor element 101 based on the calculated value of Db×Db/Da. Specifically, the evaluation determines whether the condition Db×Db/Da≥3000 [cm⁻¹] is satisfied. This configuration allows evaluation of whether the second type of noble metal (e.g. Au), evaporated from the inner pump electrode 22 is suppressed from flowing into the third internal cavity 61 and adhering to the measurement electrode 44. As a result, it is possible to provide a sensor element 101 capable of suppressing the decrease in the sensitivity to detect the NOx concentration, after a predetermined time (e.g. several hundred hours to several thousand hours) of use. Instead of evaluating whether Db×Db/Da≥3000 [cm⁻¹] is satisfied, it may be evaluated whether Db×Db/Da≥3500 [cm⁻¹] is satisfied, or it may be evaluated whether Db×Db/Da≥5000 [cm⁻¹] is satisfied.

It should be noted that for the sensor element 101 to be evaluated, the computer performs the processing of calculating the first and second diffusion resistances Da and Db, the processing of calculating Db×Db/Da, and the processing of evaluating using Db×Db/Da. However, at least some of these processes may be performed by a person.

The evaluation method for the sensor element 101 has been described. However, the processing of the evaluation method for the sensor element 101, specifically, the processing of evaluating it using Db×Db/Da, may also be implemented as a program executed by one or more computers. The program may be recorded on a computer-readable recording medium (e.g. a hard disk, SSD, ROM, FD, CD, DVD, etc.), may be distributed from one computer to another via a transmission medium (such as a communication network like the Internet or LAN), or may be transferred in other forms.

### Examples

Specifically fabricated examples of the sensor element 101 will be described as example. It should be noted that the present invention is not limited to the following example.

### Examples 1 to 19 and Comparative Examples 1 to 3

Using the manufacturing method described above, a sensor element 101 shown in FIG. 1 was produced and designated as Example 1. In addition, the temperature measurement sample corresponding to Example 1 was also produced. In producing the sensor element 101, a ceramic green sheet was formed by mixing zirconia particles with 4 mol % of stabilizing agent yttria, an organic binder, and an organic solvent, followed by tape molding. All of the outer pump electrode 23, reference electrode 42, and measurement electrode 44 were porous cermet electrodes composed of Pt and ZrO₂. Additionally, the inner pump electrode 22 and auxiliary pump electrode 51 were made from a porous cermet electrode composed of Pt, ZrO₂, and 1% Au. Using the same manufacturing method, Examples 2 to 19 and Comparative Examples 1 to 3, along with the corresponding temperature measurement samples, were also produced. In Examples 1 to 19 and Comparative Examples 1 to 3, the vertical height of the slits in the first to fourth diffusion rate-limiting sections 11, 13, 30, and 60 was changed. As a result, in Examples 1 to 19 and Comparative Examples 1 to 3, the first and second diffusion resistances Da and Db were changed, which in turn changed Db×Db/Da [cm⁻¹].

Subsequently, for Example 1 and the corresponding temperature measurement sample, the following parameters were obtained using the measurement method described above: the limiting currents Ipa and Ipb of the main pump cell 21 and the measurement pump cell 41; the temperatures Ta and Tb of the inner pump electrode 22 and the measurement electrode 44; the oxygen partial pressure Poe in the measurement gas; and the oxygen partial pressures Poda and Podb in the first internal cavity 20 and the third internal cavity 61, respectively. Then, for Example 1, the first and second diffusion resistances Da and Db were calculated using the Equations (1) and (2) described above, and Db×Db/Da was calculated using the obtained Da and Db values. Similarly, Db×Db/Da was calculated for Examples 2-19 and Comparative Examples 1 to 3 using the same method. The calculated Db×Db/Da values for Examples 1 to 19 and Comparative Examples 1 to 3 are shown in Table 1.

TABLE 1

| | Db × Db/Da[cm⁻¹] | ΔIp2s[%] |
|---|---|---|
| Example 1 | 4746 | −25.38 |
| Example 2 | 4778 | −30.37 |
| Example 3 | 6517 | −20.44 |
| Example 4 | 5696 | −22.04 |
| Example 5 | 5792 | −13.36 |
| Example 6 | 7115 | −13.07 |
| Example 7 | 6629 | −12.98 |
| Example 8 | 5373 | −12.22 |
| Example 9 | 5320 | −16.85 |
| Example 10 | 11568 | −11.84 |
| Example 11 | 11832 | −3.62 |
| Example 12 | 3702 | −31.85 |
| Example 13 | 9199 | −6.97 |
| Example 14 | 8917 | −16.59 |
| Example 15 | 9240 | −6.56 |
| Example 16 | 9303 | −1.49 |
| Example 17 | 8277 | −6.78 |
| Example 18 | 3481 | −37.92 |
| Example 19 | 3730 | −27.03 |
| Comparative | 2247 | −101.99 |
| Example 1 | | |
| Comparative | 2339 | −98.34 |
| Example 2 | | |
| Comparative | 2192 | −100.00 |
| Example 3 | | |

### Evaluation Test

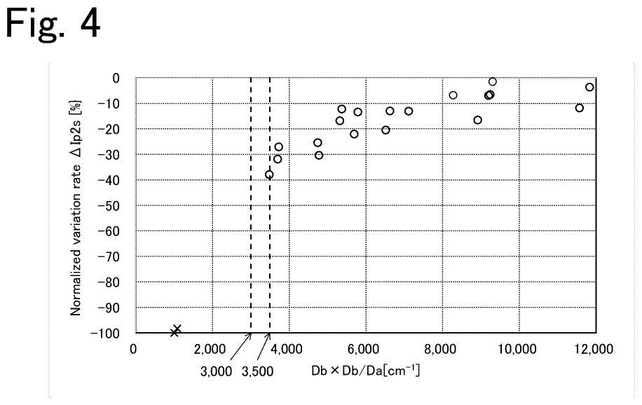

A gas sensor 100 including the sensor element 101 of Example 1 was installed in a pipe such that the tip side portion of the sensor element 101 protruding into the pipe. The heater 72 was energized to heat the sensor element 101 to a temperature of 800° C. In this state, a model gas was prepared, in which the base gas was nitrogen, the oxygen concentration was 21%, the NOx concentration was 2000 ppm, and the pressure of 1 atm. This model gas was then introduced into the pipe as the measurement gas. Next, for Example 1, the pump current Ip2 was sequentially measured while performing both the adjustment pump control processing and the measurement pump control processing. The rate of change ΔIp2 [%] between the pump current Ip2 [A] measured at the start of the test and the pump current Ip2 measured after 500 hours was calculated. Specifically, the difference between the pump current Ip2 after 500 hours and the pump current Ip2 at the start of the test was divided by the pump current Ip2 at the start of the test to compute the rate of change ΔIp2 [%]. Using the same method, the rate of change ΔIp2 was calculated for Examples 2-19 and Comparative Examples 1-3. Furthermore, the rate of change ΔIp2 for Examples 1-19 and Comparative Examples 1-3 was normalized by setting the rate of change ΔIp2 for Comparative Example 3 to −100 [%], resulting in the normalized variation rate ΔIp2s. The results are shown in Table 1. Additionally, a graph showing the relationship between Db×Db/Da and the normalized variation rate ΔIp2s for Examples 1-19 and Comparative Examples 1-3 is shown in FIG. 4. In FIG. 4, Examples 1-19 are marked with circle markers, and Comparative Examples 1-3 are marked with X markers.

As shown in Table 1 and FIG. 4, sensor elements 101 (Examples 1-19) that satisfy Db×Db/Da≥3000 [cm⁻¹] exhibit a significantly smaller absolute value of the normalized variation rate ΔIp2s compared to sensor elements 101 (Comparative Examples 1-3) that do not satisfy the condition Db×Db/Da≥3000 [cm⁻¹]. Furthermore, sensor elements 101 (Examples 1-17, 19) that satisfy Db×Db/Da≥3500 [cm⁻¹] exhibit a smaller absolute value of the normalized variation rate ΔIp2s compared to sensor elements 101 (Example 18) that satisfy 3000<Db×Db/Da<3500 [cm⁻¹]. Additionally, sensor elements 101 (Examples 3-11, 13-17) that satisfy Db×Db/Da≥5000 [cm⁻¹] exhibit a smaller absolute value of the normalized variation rate ΔIp2s compared to sensor elements 101 (Examples 1, 2, 12, 18, 19) that satisfy 3000<Db×Db/Da<5000 [cm⁻¹]. A smaller absolute value of the normalized variation rate ΔIp2s indicates that the decrease in sensitivity to detect the NOx concentration after 500 hours of use is suppressed. In other words, Examples 1-19 show less decrease in sensitivity to detect the NOx concentration after 500 hours of use compared to Comparative Examples 1-3. Moreover, Examples 1-17, and 19 show a greater degree of suppression of the decrease in sensitivity to detect the NOx concentration after 500 hours of use compared to Example 18. Furthermore, Examples 3-11, and 13-17 show a greater degree of suppression of the decrease in sensitivity to detect the NOx concentration after 500 hours of use compared to Examples 1, 2, 12, 18, and 19.

What is claimed is:

1. A sensor element configured to detect a concentration of a specific gas in a measurement gas, the sensor element comprising:
an element body having an oxygen-ion-conductive solid electrolyte layer and a measurement gas flow path provided therein, the measurement gas flow path configured to introduce and circulate the measurement gas from a gas inlet;
an adjustment pump cell having an inner electrode disposed in an oxygen concentration adjustment chamber within the measurement gas flow path, the inner electrode containing a first type of noble metal with catalytic activity and a second type of noble metal configured to suppress the catalytic activity of the first type of noble metal with respect to the specific gas in the measurement gas, the adjustment pump cell being configured to adjust an oxygen concentration in the oxygen concentration adjustment chamber; and
a measurement pump cell having a measurement electrode disposed in a measurement chamber located downstream of the oxygen concentration adjustment chamber within the measurement gas flow path, the measurement pump cell being configured to adjust the oxygen concentration in the measurement chamber,
wherein, when a first diffusion resistance from the outside to the inner electrode through the gas inlet is defined as Da, and a second diffusion resistance from the outside to the measurement electrode through the gas inlet is defined as Db, the sensor element is configured such that Db×Db/Da≥3000 [cm⁻¹] is satisfied.

2. The sensor element according to claim 1,
wherein the sensor element is configured such that Db×Db/Da≥3500 [cm⁻¹] is satisfied.

3. The sensor element according to claim 1,
wherein the sensor element includes a plurality of the adjustment pump cells, and
the first diffusion resistance Da is a diffusion resistance from the outside to the most upstream inner electrode through the gas inlet.

4. The sensor element according to claim 1,
wherein, when the Faraday constant is defined as F [A·sec/mol], the diffusion coefficient of oxygen is defined as D [cm²/sec], the gas constant is defined as R [cm³·atm/mol·K], temperatures of the inner electrode and the measurement electrode are defined as Ta and Tb [K], respectively, limiting currents of the adjustment pump cell and the measurement pump cell are defined as Ipa and Ipb [A], respectively, an oxygen partial pressure in the measurement gas is defined as Poe [atm], and oxygen partial pressures in the oxygen concentration adjustment chamber and the measurement chamber are defined as Poda and Podb [atm], respectively, the first and second diffusion resistances Da and Db are expressed by Equation (A) and Equation (B), respectively,
$$Da = 4 \times F \times D / ( R \times Ta ) \times 1 / Ipa \times ( Poe - Poda ) \qquad ( A )$$
$$Db = 4 \times F \times D / ( R \times Tb ) \times 1 / Ipb \times ( Poe - Podb ) . \qquad ( B )$$

5. A gas sensor comprising:
the sensor element according to claim 1.

6. An evaluation method for a sensor element configured to detect a concentration of a specific gas in a measurement gas, the sensor element comprising:
an element body having an oxygen-ion-conductive solid electrolyte layer and a measurement gas flow path provided therein, the measurement gas flow path configured to introduce and circulate the measurement gas from a gas inlet;
an adjustment pump cell having an inner electrode disposed in an oxygen concentration adjustment chamber within the measurement gas flow path, the inner electrode containing a first type of noble metal with catalytic activity and a second type of noble metal configured to suppress the catalytic activity of the first type of noble metal with respect to the specific gas in the measurement gas, the adjustment pump cell being configured to adjust an oxygen concentration in the oxygen concentration adjustment chamber; and
a measurement pump cell having a measurement electrode disposed in a measurement chamber located downstream of the oxygen concentration adjustment chamber within the measurement gas flow path, the measurement pump cell being configured to adjust the oxygen concentration in the measurement chamber,
wherein the evaluation method includes a step of evaluating the sensor element under evaluation by using a value of Db×Db/Da, where a first diffusion resistance from the outside to the inner electrode through the gas inlet is defined as Da, and a second diffusion resistance from the outside to the measurement electrode through the gas inlet is defined as Db.

7. The evaluation method for the sensor element according to claim 6,
wherein, in the step, when the Faraday constant is defined as F [A·sec/mol], the diffusion coefficient of oxygen is defined as D [cm²/sec], the gas constant is defined as R [cm³·atm/mol·K], temperatures of the inner electrode and the measurement electrode are defined as Ta and Tb [K], respectively, limiting currents of the adjustment pump cell and the measurement pump cell are defined as Ipa and Ipb [A], respectively, an oxygen partial pressure in the measurement gas is defined as Poe [atm], and oxygen partial pressures in the oxygen concentration adjustment chamber and the measurement chamber are defined as Poda and Podb [atm], respectively, the first and second diffusion resistances Da and Db are expressed by Equation (C) and Equation (D), respectively,
$$Da = 4 \times F \times D / ( R \times Ta ) \times 1 / Ipa \times ( Poe - Poda ) \qquad ( C )$$
$$Db = 4 \times F \times D / ( R \times Tb ) \times 1 / Ipb \times ( Poe - Podb ) . \qquad ( D )$$

8. A program for causing one or more computers to execute the step of the evaluation method for the sensor element according to claim 6.
